(19) United States
(12) Patent Application Publication
(10) Pub. No.: US 2023/0388991 A1
(43) Pub. Date: Nov. 30, 2023

(54) BANDWIDTH CONFIGURATION METHOD AND USER EQUIPMENT

(71) Applicant: Sharp Kabushiki Kaisha, Sakai City, Osaka (JP)

(72) Inventors: Chongming ZHANG, Shanghai (CN); Renmao LIU, Shanghai (CN)

(21) Appl. No.: 18/031,641

(22) PCT Filed: Oct. 8, 2021
(86) PCT No.: PCT/CN2021/122591

§ 371 Date: Apr. 13, 2023

(30) Foreign Application Priority Data
Oct. 16, 2020 (CN) 202011114672.7

(51) Int. Cl. H04W 72/0457; H04W 72/1268; H04W 72/232

(52) U.S. Cl. CPC H04W 72/0457; H04W 72/1268; H04W 72/232

(57) ABSTRACT

Provided in the present disclosure are a bandwidth configuration method and user equipment. The bandwidth configuration method is performed by user equipment (UE), and the UE is configured to support or allow inactive state data transmission. The method includes the following steps: after the UE enters an inactive state, if a required condition for inactive state data transmission thereof is fulfilled, the UE activating an uplink bandwidth part (UL BWP) for inactive state data transmission (IDT); and after transmitting uplink data, the UE receiving response information transmitted by a base station side.

### TECHNICAL FIELD

The present disclosure relates to the technical field of wireless communications, and more specifically relates to a bandwidth configuration method and user equipment for performing the method.

### BACKGROUND

With the rapid growth of mobile communications and great progress of technology, the world will move toward a fully interconnected network society where anyone or anything can acquire information and share data anytime and anywhere. It is estimated that there will be 50 billion interconnected devices by 2020, of which only about 10 billion may be mobile phones and tablet computers. The rest are not machines communicating with human beings but machines communicating with one another. Therefore, how to design a system to better support the Internet of Everything is a subject needing further and intensive study.

In the future access technology, the system can operate in high frequency bands and the operation bandwidth of the system can reach greater than 400 MHz, but the operation bandwidth that can be supported by user equipment (UE) itself is far lower than the operation bandwidth of the system. As a result, the concept of Bandwidth Part (BWP) is introduced. The so-called BWP refers to the feature of dividing the operation bandwidth of the system into a plurality of bandwidth parts. A network node (for example, a base station) can configure one or a plurality of BWPs for the UE according to the bandwidth capacity supported by the UE. When data needs to be transmitted, the UE can operate on a plurality of BWPs at the same time, which greatly improves the transmission rate. When the UE has no data to be transmitted, the UE only needs to monitor one of the BWPs and waits for scheduling of the base station, so as to reduce energy consumption. A BWP configuration may be common or dedicated to a UE. When a UE is in an idle state or an INACTIVE state, the UE can receive a common BWP configuration in system information and use the same to enter a connected state; after the UE enters the connected state, the UE can receive a dedicated BWP configuration of a base station and operate on one or a plurality of activated BWPs of the configured BWPs.

BWPs are divided into uplink BWPs (UL BWP) and downlink BWPs (DL BWP). The UL BWP refers to the direction in which the UE performs transmission and the base station performs reception, and the DL BWP refers to the direction in which the base station performs transmission and the UE performs reception.

In the current study subjects, the UE in the INACTIVE state is supported to perform data transmission on an uplink resource corresponding to a pre-configured uplink grant (UL grant). Such configured grant is on a specific UL BWP. After transmitting uplink data by means of the configured grant, the UE needs to receive response information transmitted by the base station. Such response information is transmitted to the UE on a certain DL BWP. Therefore, how to determine and apply a DL BWP for receiving downlink response information is a problem that needs to be solved.

### SUMMARY

The objective of the present invention is to provide a solution to the problem of how to determine and apply a DL BWP for receiving downlink response information, etc.

According to an aspect of the present invention, provided is a bandwidth configuration method, the method being performed by user equipment (UE), and the UE being configured to support or allow inactive state data transmission, wherein
the method comprises the following steps:
after the UE enters an inactive state, if a required condition for inactive state data transmission thereof is fulfilled, the UE activating an uplink bandwidth part (UL BWP) for inactive state data transmission (IDT); and
after transmitting uplink data, the UE receiving response information transmitted by a base station side.

In the bandwidth configuration method, preferably,
the UL BWP is a pre-configured UL BWP comprising a configured grant (CG) for IDT.

In the bandwidth configuration method, preferably,
the UL BWP has a default configuration, and
the configured CG is a CG on a common UL BWP provided by system information; or,
the configured CG is a CG on a common UL BWP configured for the UE when in a connected state.

In the bandwidth configuration method, preferably,
when initializing inactive state data transmission, the UE restores and applies configuration information of a common UL BWP stored by the UE.

In the bandwidth configuration method, preferably,
the response information is a PDCCH scrambled by an RNTI of the UE, or a downlink assignment or a PDSCH indicated on a PDCCH, and the response information is transmitted on a downlink bandwidth part (DL BWP).

In the bandwidth configuration method, preferably,
the DL BWP is a DL BWP associated with the UL BWP, and
in addition to activating the UL BWP, the UE further activates the DL BWP associated with the UL BWP.

In the bandwidth configuration method, preferably,
the DL BWP is a common DL BWP provided by system information, and
after completing uplink transmission, the UE monitors a PDCCH scrambled by an IDT-RNTI on the common DL BWP according to a search space provided by the system information and used for the PDCCH scrambled by the IDT-RNTI.

In the bandwidth configuration method, preferably,
the DL BWP is a common DL BWP stored by the UE, and
when initializing inactive state data transmission, the UE restores and applies configuration information of the common DL BWP stored by the UE.

In the bandwidth configuration method, preferably,
for a UL BWP or a DL BWP activated in the inactive state, the UE performs the following operation:
initializing or reinitializing a configured uplink grant on the UL BWP or the DL BWP;
monitoring a PDCCH on the UL BWP;
performing transmission in an uplink shared channel on the DL BWP; or
performing reception in a downlink shared channel on the UL BWP.

According to another aspect of the present invention, user equipment is provided, comprising:
a processor; and
a memory storing instructions,
wherein the instructions, when run by the above processor, cause the user equipment to perform the bandwidth configuration method described above.

In the bandwidth configuration method and the corresponding user equipment according to the present disclosure, a DL BWP for receiving downlink response information can be determined and applied in an inactive state.

### BRIEF DESCRIPTION OF THE DRAWINGS

In order to understand the present disclosure and advantages thereof more fully, reference will now be made to the following description made in conjunction with the accompanying drawings.

FIG. 1 is a flowchart showing a bandwidth configuration method according to an embodiment of the present invention.

FIG. 2 is a schematic structural block diagram of user equipment according to the present invention.

### DETAILED DESCRIPTION

The embodiments of the present disclosure will be described below with reference to accompanying drawings. However, it should be understood that the descriptions are merely exemplary rather than limiting the scope of the present disclosure. Besides, in the following description, the description of commonly-known structures and techniques is omitted, so as to avoid unnecessarily obscuring the concept of the present disclosure.

The terms used herein are only for describing specific embodiments rather than limiting the present disclosure. The words “a,” “one (type)” and “the” or the like used herein should also include the meanings of “a plurality of” and “various,” unless otherwise clearly specified in the context. In addition, the terms “comprising,” “including” or the like used herein indicate the existence of the stated features, steps, operations and/or components, but do not exclude the existence or addition of one or a plurality of other features, steps, operations or components.

All terms used herein (including technical and scientific terms) have the meanings generally understood by one skilled in the art, unless otherwise defined. It should be noted that the terms used herein should be interpreted as having meanings consistent with the context of the present description, and should not be interpreted in an idealized or too stereotypical way.

The drawings illustrate some block diagrams and/or flowcharts. It should be understood that some or a combination of the blocks in the block diagrams and/or flowcharts may be implemented by computer program instructions. These computer program instructions can be provided to a processor of a general-purpose computer, a special-purpose computer, or other programmable data processing apparatuses, so that these instructions, when executed by the processor, can create apparatuses for implementing the functions/operations described in the block diagrams and/or flowcharts.

Therefore, the technology of the present disclosure may be implemented in the form of hardware and/or software (including firmware, microcode, etc.). In addition, the technology of the present disclosure may be used in the form of a computer program product on a computer-readable medium having instructions stored therein, and the computer program product can be used by an instruction execution system or used in combination with an instruction execution system. In the context of the present disclosure, the computer-readable medium may be any medium capable of containing, storing, conveying, propagating, or transmitting instructions. For example, the computer-readable medium may include, but is not limited to, electrical, magnetic, optical, electromagnetic, infrared or semiconductor systems, apparatuses, devices, or propagation media. Specific examples of the computer-readable medium include: a magnetic storage apparatus, such as a magnetic tape or a hard disk drive (HDD); an optical storage apparatus such as a compact disc read-only memory (CD-ROM); a memory such as a random access memory (RAM) or a flash memory; and/or a wired/wireless communication link.

A plurality of embodiments according to the present invention are specifically described below by using an NR mobile communications system and its subsequent evolved version as an exemplary application environment. However, it should be noted that the present invention is not limited to the following embodiments, but is applicable to many other wireless communication systems, such as an LTE cellular communications system, and is applicable to other base stations and terminal devices, such as base stations and terminal devices supporting eMTC, MMTC, and so on.

Prior to the specific description, several terms mentioned in the present invention are illustrated as follows. The terms involved in the present invention shall have the meanings set forth below, unless otherwise indicated. In addition, a “default” (BWP) configuration described herein may be “default” or “have a default value,” may be a (BWP) configuration agreed upon by a UE side and a network or base station side, may be indicated directly in signaling, or may be a configuration agreed upon in advance, and does not need to be carried in specific signaling.
UE: User Equipment/terminal device
MAC: Medium Access Control
RRC: Radio Resource Control
PRACH: Physical Random Access Channel
RNTI: Radio Network Temporary Identity
C-RNTI: Cell-Radio Network Temporary Identifier
PDCCH: Physical Downlink Control Channel
PDSCH: Physical Downlink Shared Channel
CSI: Channel State Information
SRS: Sounding Reference Signal
UL-SCH: Uplink Shared Channel
DL-SCH: Downlink Shared Channel

In NR access technology, the states of the UE may be divided into an idle state, a connected state, and an inactive state (INACTIVE) according to the connection status of the UE over the air interface. In the inactive state, although the UE has no connection at the air interface, an access stratum context (AS context) of the UE is reserved on the base station side and the UE side, and the UE is assigned a resume ID, which is an identity used by the UE to resume an RRC connection. This intermediate state can be considered as a connection suspended state, or it can be considered as a connection inactive state.

Before entering the inactive state from the connected state, the UE has received a dedicated BWP configuration from the base station and operates on activated BWPs therein. However, after the UE enters the inactive state, no activated BWP is present due to no connection at the air interface, but the UE still stores the dedicated BWP configuration.

In the above scenario, in order to perform inactive state data transmission, the UE needs to determine a UL BWP for transmitting data and a DL BWP for receiving response information.

### Common BWP

Configuration information of a common BWP of a cell is broadcast in system information of the cell, e.g., a system information block 1. The common BWP may also be referred to as an initial BWP. The common BWP includes an uplink common BWP and a downlink common BWP, which may also be referred to as an initial UL BWP and an initial DL BWP.

After the UE enters the connected state, on the basis of the configuration information of the common BWP provided by the system information, the base station may further provide dedicated configuration information additionally, thereby forming a common BWP dedicated to the UE, which may also be referred to as a connected-state common BWP. Similarly, the common BWP in the connected state also includes an uplink BWP and a downlink BWP.

### Activation of BWP

For a UE in the connected state, when one (uplink or downlink) BWP is activated, the UE can perform one or a plurality of the following operations on the activated BWP:
performing uplink shared channel transmission on the (uplink) BWP;
performing transmission on a RACH resource on the (uplink) BWP;
monitoring a PDCCH on the (downlink) BWP;
reporting CSI of the BWP;
transmitting an SRS on the BWP;
performing reception on a downlink shared channel on the (downlink) BWP; and
initializing or reinitializing a configured uplink grant on the BWP.

### Configured Grant (CG)

Here, a CG mainly refers to an uplink CG, which may be used by the UE to transmit data to the base station. An uplink CG configuration includes or corresponds to time and frequency domain information of an uplink resource, e.g., a period of the uplink resource, a starting symbol location, BWP frequency band information or resource block information, etc.

### Inactive State Data Transmission (IDT)

IDT means that a UE can transmit, to a base station or a network layer, user data or RRC signaling in an inactive state. Herein, an uplink resource for data or signaling transmission mainly refers to an uplink resource corresponding to a configured grant. Further, since the total amount of data transmitted in the IDT manner is relatively small, such transmission may also be referred to as small data transmission.

### PDCCH Monitoring

Scheduling information for uplink or downlink resources is carried in a PDCCH. For a particular UE, an RNTI belonging to the UE may be assigned. Then, a PDCCH is received in a configured search space, and it is determined whether the PDCCH is scrambled by the RNTI belonging to the UE. If so, the UE can determine that the PDCCH is transmitted to the UE itself, and can receive downlink control information carried in the PDCCH, so as to acquire uplink or downlink resource information. If the PDCCH is not scrambled by the RNTI belonging to the UE, said PDCCH is not transmitted to the UE. Such kind of PDCCH receiving, determining, and processing process may be referred to as a PDCCH monitoring process.

The bandwidth configuration method according to the embodiments of the present disclosure will be described below in combination with specific examples.

### Embodiment 1

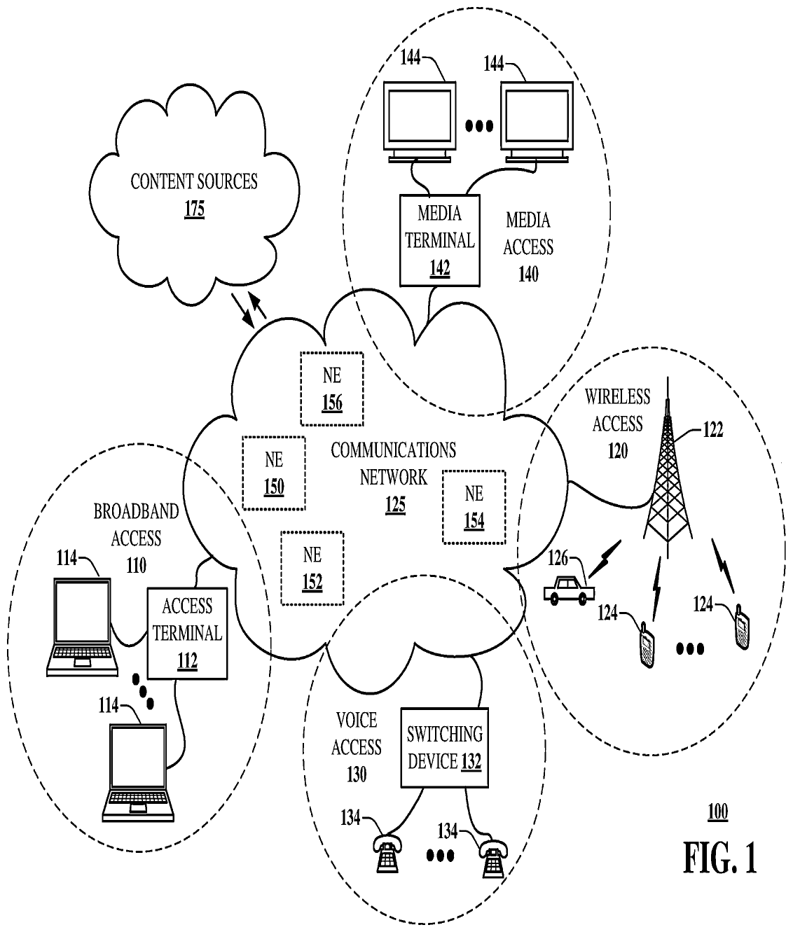

First, a UE should be configured to have the function of supporting or allowing inactive state data transmission. As shown in FIG. 1,
in S101, after the UE enters an inactive state, and if a required condition for inactive state data transmission thereof is fulfilled, for example, if uplink data arrives and/or an uplink alignment timer is still running, the UE can activate a UL BWP for inactive state data transmission (IDT).

Such UL BWP may be pre-configured, and include a configured grant for inactive state data transmission (IDT).

For example, when previously in a connected state, the UE receives configuration information transmitted by a base station, and is configured with a configured grant for inactive state data transmission. Then, a UL BWP associated with this CG is the UL BWP for IDT. Such UL BWP may have a corresponding identity, e.g., a BWP identity (BWP ID). The base station may indicate the BWP ID of the UL BWP in related configuration information for inactive state data transmission, so that the UE can activate the BWP corresponding to this BWP ID when the condition is fulfilled.

All activated BWPs are deactivated when the UE enters the inactive state from the connected state, so that in the above scenario, when the required condition for the IDT is fulfilled, the UE needs to activate the UL BWP for IDT first. Only on the activated UL BWP, can the CG configured therefor be reinitialized, and be used for data transmission.

Such UL BWP may also have a default configuration. That is, the related configuration information for performing inactive state data transmission does not indicate the UL BWP or the UL BWP ID associated with the CG.

In this scenario, the UE may consider that the configured CG is on a common UL BWP provided by system information. When the UE operates in the inactive state, the common UL BWP can always be used for transmission, and thus activation may not need to be performed. This activation operation may be skipped, and the common UL BWP may be applied directly.

In another solution for the default configuration, the UE may consider that the configured CG is located on or corresponds to a common UL BWP configured for the UE when in the connected state.

In the prior art, after the UE enters the connected state, on the basis of the configuration of the common UL BWP provided by the system information, the base station may further provide dedicated configuration information additionally, thereby forming a common UL BWP dedicated to the UE, which may also be referred to as a connected-state common UL BWP.

In the prior art, when the UE enters the inactive state from the connected state, all configuration information is stored, and can only be restored and used when a restoration instruction is received. The configuration information of the above connected-state common UL BWP is also stored, so that such kind of connected-state common UL BWP may also be referred to as a common UL BWP whose configuration information is stored by the UE, or may be briefly referred to as a common UL BWP stored by the UE.

To support inactive state data transmission, when the condition for the IDT is fulfilled, the UE in the inactive state may partially restore some configuration information, e.g., the configuration information of the connected-state common UL BWP mentioned here, and use the same. In this way, the UE can perform uplink data transmission, and a specific implementation may be as follows:

When initializing inactive state data transmission, the UE restores and applies the configuration information of the common UL BWP. Here, the restored and applied configuration information of the common UL BWP refers to the configuration information stored by the UE when entering the inactive state from the connected state.

In S102, after transmitting uplink data, the UE needs to receive response information transmitted by the base station side. Such kind of response information may be a PDCCH scrambled by an RNTI belonging to the user UE, or a downlink assignment or a PDSCH indicated on a PDCCH. All of such kind of response information is transmitted on a DL BWP. The DL BWP here may be:
Option 1: DL BWP associated with the above UL BWP

In this scenario, in addition to needing to activate the UL BWP as described above, the UE further needs to activate a DL BWP associated with the UL BWP;
for example, a DL BWP having an ID the same as the above UL BWP ID, or a DL BWP whose ID may be calculated according to the above UL BWP ID.

In this scenario, in addition to needing to activate the UL BWP as described above, the UE further needs to activate a DL BWP having the same number as that of the UL BWP or a DL BWP related to the UL BWP ID, and uses the same to receive a response message.

For another example, configuration information related to the IDT is used to indicate a DL BWP for receiving a response message, and may specifically indicate a BWP ID of the DL BWP for receiving a response message. Such DL BWP may also be considered to be a DL BWP associated with the above UL BWP.

In this scenario, in addition to needing to activate the UL BWP as described above, the UE further needs to activate this indicated DL BWP to receive a response message.
Option 2: Common DL BWP provided by system information

As previously described, in default of a UL BWP, the UE may consider that the CG is on a common UL BWP. Similarly, in default of a DL BWP, the UE can receive a response message on a common DL BWP.

After completing uplink transmission, the UE monitors a specific PDCCH in a search space on the common DL BWP, e.g., a search space for a PDCCH scrambled by a dedicated RNTI. An RNTI related to IDT transmission may be defined here, e.g., an IDT-RNTI. The IDT-RNTI here may further be equal to a C-RNTI stored by the UE.

Since configuration information of the common DL BWP is broadcast in system information, the base station further needs to broadcast, in the system information, a search space for the PDCCH scrambled by the IDT-RNTI. The search space is on the common DL BWP, or is associated with the common DL BWP.

Then, after completing uplink transmission, the UE monitors the PDCCH scrambled by the IDT-RNTI on the common DL BWP according to the search space provided by the system information and used for the PDCCH scrambled by the IDT-RNTI.
Option 3: Connected-state common DL BWP

The common DL BWP here is different from that in Option 2. After the UE enters the connected state, on the basis of the configuration of the common DL BWP provided by the system information, the base station may further provide dedicated configuration information additionally, thereby forming a common DL BWP dedicated to the UE, which may also be referred to as a connected-state common DL BWP.

In the prior art, when the UE enters the inactive state from the connected state, all configuration information is stored, and can only be restored and used when a restoration instruction is received. The configuration information of the above connected-state common DL BWP is also stored, so that such kind of connected-state common DL BWP may also be referred to as a common DL BWP whose configuration information is stored by the UE, or may be briefly referred to as a common DL BWP stored by the UE.

To support inactive state data transmission, when the condition for the IDT is fulfilled, the UE in the inactive state may partially restore some configuration information, e.g., the configuration information of the connected-state common DL BWP mentioned here, and use the same. A specific implementation may be as follows:

When initializing inactive state data transmission, the UE restores and applies the configuration information of the common DL BWP. Here, the restored and applied configuration information of the common DL BWP refers to the configuration information stored by the UE when entering the inactive state from the connected state.

With reference to the connected-state UL BWP used for IDT in a default state as described above, when initializing inactive state data transmission, the UE may restore and apply the configuration information of the common BWP, including UL and DL. Here, the restored and applied configuration information of the common BWP refers to the configuration information stored by the UE when entering the inactive state from the connected state.

### Embodiment 2

As mentioned in Embodiment 1, UE needs to activate a UL BWP or DL BWP in order to perform IDT. After the BWP is activated, the UE can perform operations according to regulations of BWP activation in a connected state.

In particular, since the UE is currently in a non-connected state, for a UL/DL BWP activated in the inactive state, the UE may perform the following operations, in which the BWP may be considered to be partially activated at the time:
initializing or reinitializing a configured uplink grant on the BWP, wherein preferably, this operation is related only to a configured uplink grant for IDT;
monitoring a PDCCH on the (downlink) BWP, and preferably monitoring a PDCCH related to IDT;
performing transmission on an uplink shared channel on the (uplink) BWP; and
performing reception on a downlink shared channel on the (downlink) BWP.

As compared to a BWP activated in the connected state, for the partially activated BWP, the UE may not report CSI, or may not transmit an SRS.

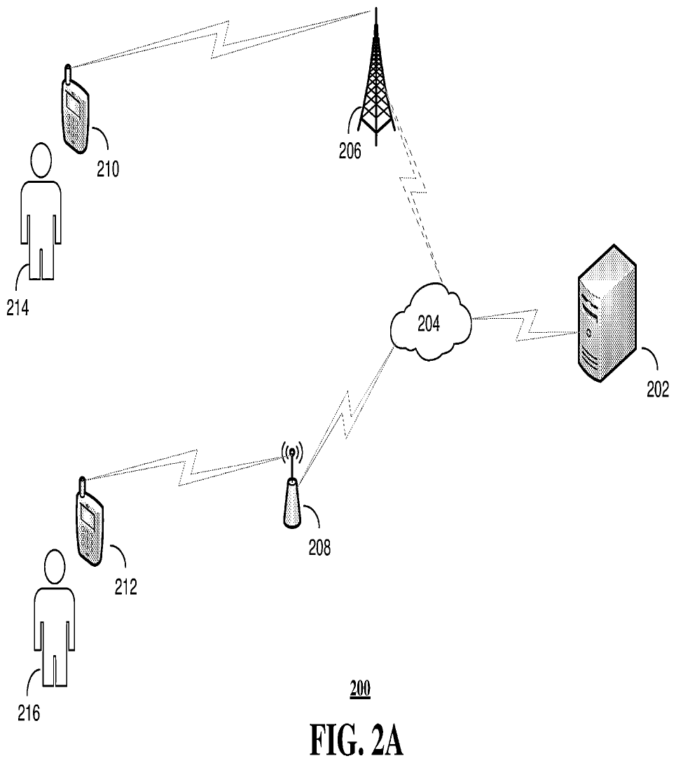

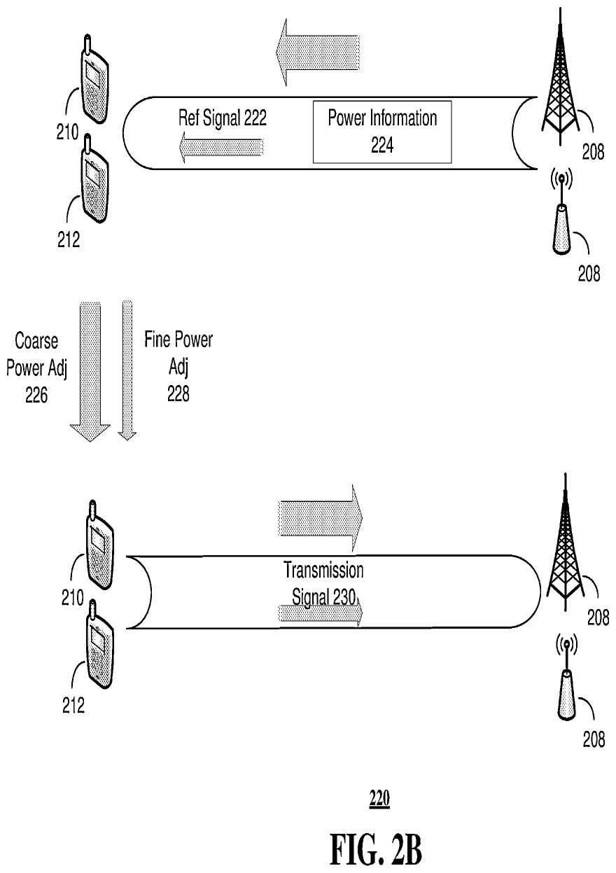

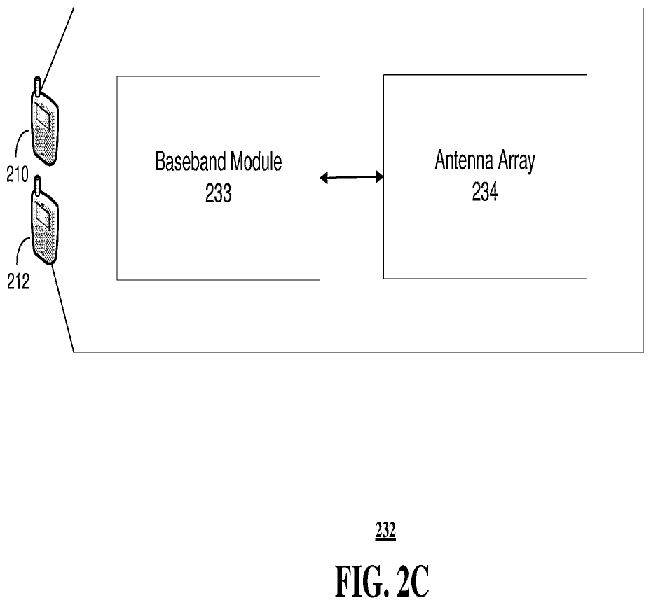

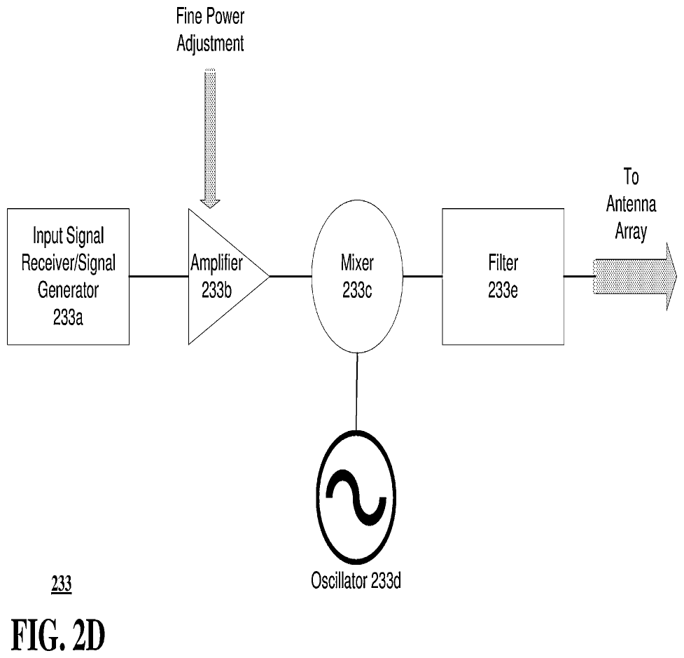

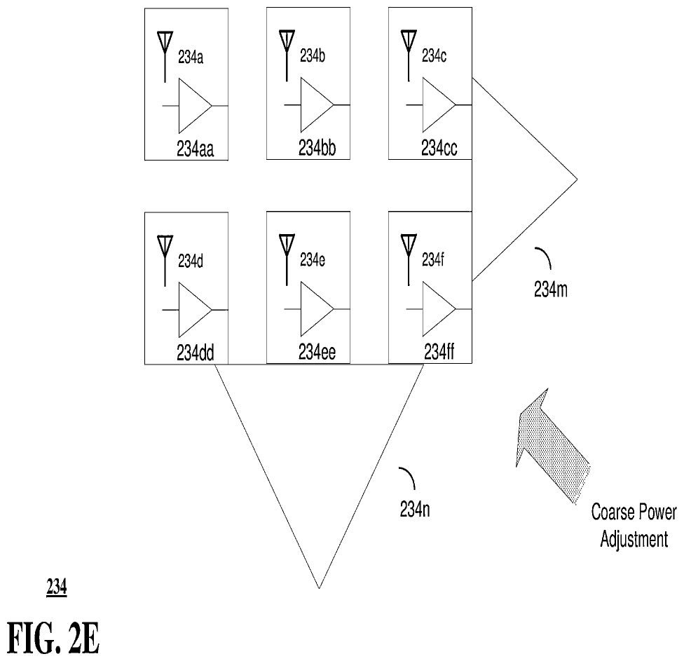

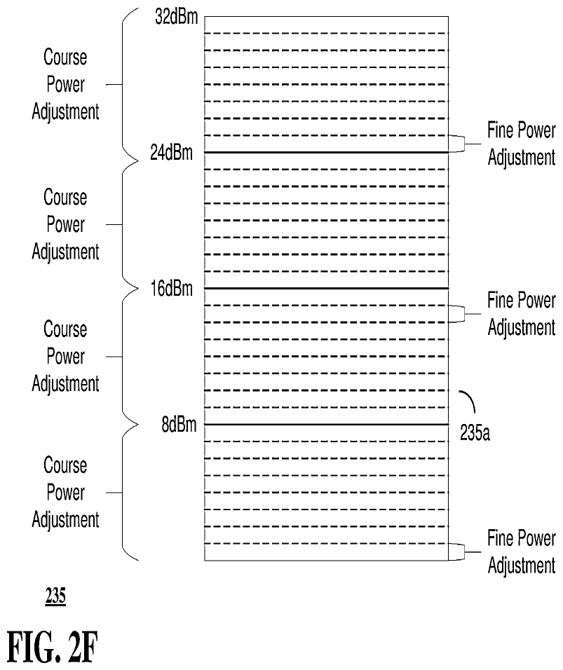

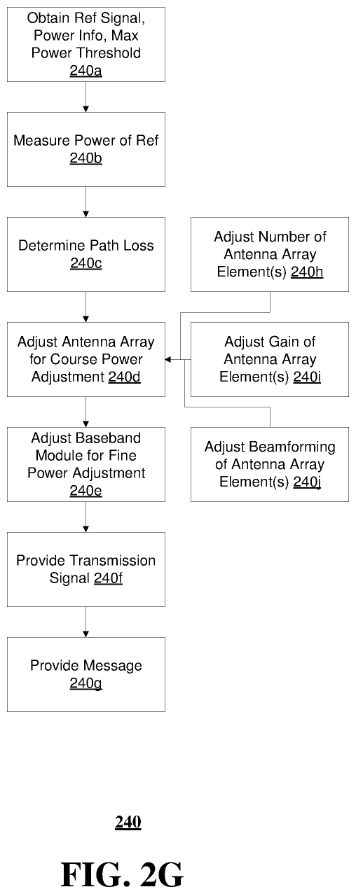

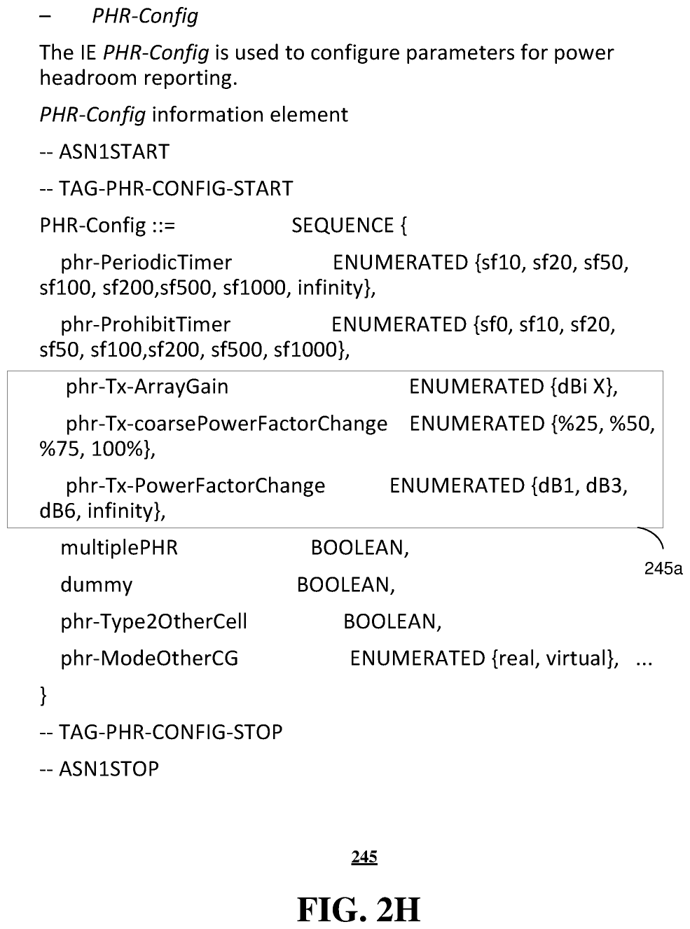

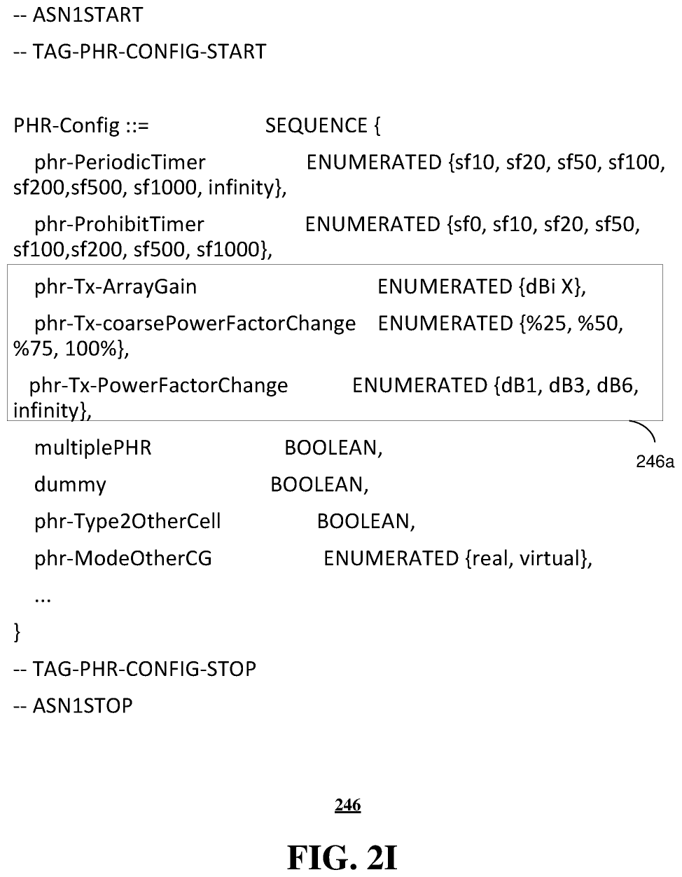

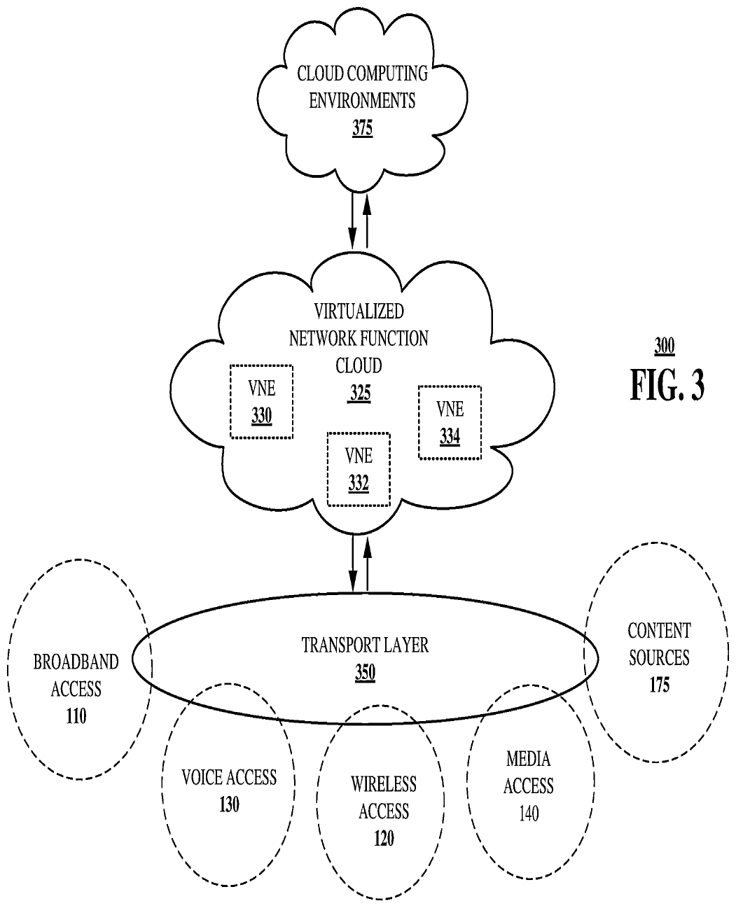

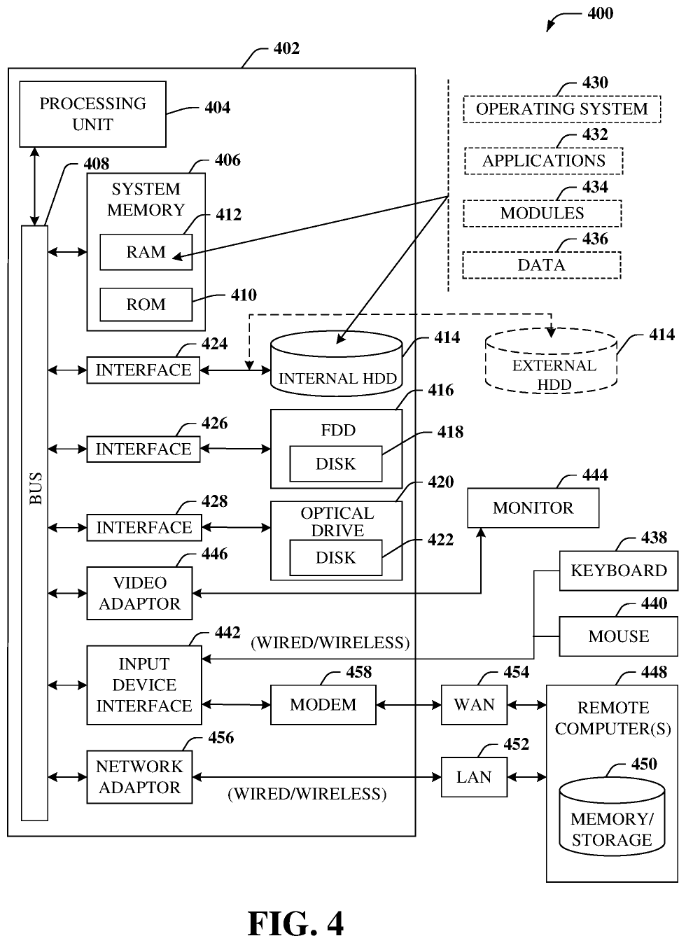

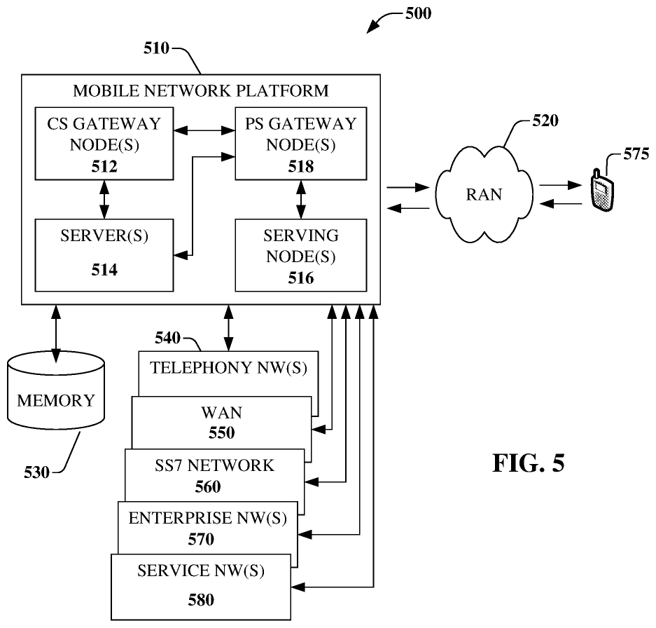

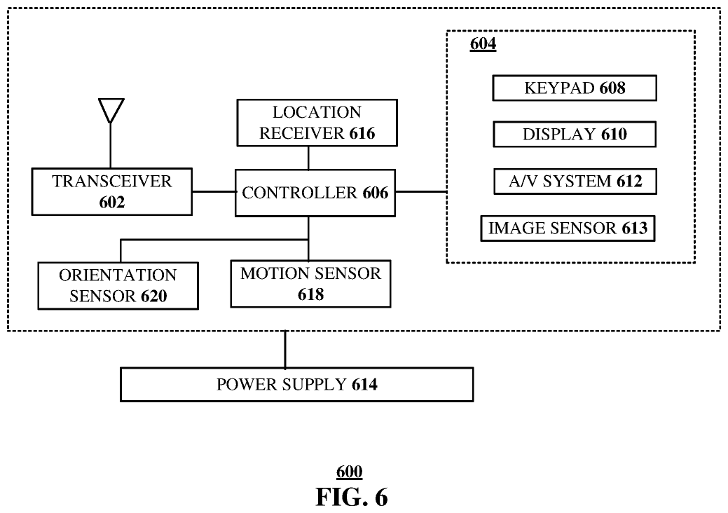

FIG. 2 is a schematic structural block diagram of user equipment according to the present invention. As shown in FIG. 2, user equipment (UE) 200 includes a processor 201 and a memory 202. The processor 201 may include, for example, a microprocessor, a microcontroller, an embedded processor, and the like. The memory 202 may include, for example, a volatile memory (such as a random access memory (RAM)), a hard disk drive (HDD), a non-volatile memory (such as a flash memory), or other memories. The memory 202 stores program instructions. The instructions, when run by the processor 201, can perform the above method performed by user equipment as described in detail in the present invention.

The program running on the device according to the present invention may be a program that enables the computer to implement the functions of the embodiments of the present invention by controlling a central processing unit (CPU). The program or information processed by the program may be temporarily stored in a volatile memory (for example, a random access memory (RAM)), a hard disk drive (HDD), a non-volatile memory (for example, a flash memory), or other memory systems.

The program for implementing the functions of the embodiments of the present invention may be recorded on a computer-readable recording medium. The corresponding functions may be achieved by reading programs recorded on the recording medium and executing them by the computer system. The phrase “computer system” herein may be a computer system embedded in the device, which may include operating systems or hardware (e.g., peripherals). The phrase “computer-readable recording medium” may refer to a semiconductor recording medium, an optical recording medium, a magnetic recording medium, a recording medium for programs that are dynamically stored for a short time, or any other recording medium readable by a computer.

Various features or functional modules of the device used in the above embodiments may be implemented or executed by circuits (for example, monolithic or multi-chip integrated circuits). Circuits designed to execute the functions described in this description may include general-purpose processors, digital signal processors (DSPs), application specific integrated circuits (ASICs), field programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of the advances in semiconductor technology, one or a plurality of embodiments of the present invention may also be implemented using these new integrated circuit technologies.

Furthermore, the present invention is not limited to the embodiments described above. Although various examples of the embodiments have been described, the present invention is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present invention have been described in detail above with reference to the accompanying drawings. However, the specific structures are not limited to the above embodiments. The present invention also includes any design modifications that do not depart from the main idea of the present invention. In addition, various modifications can be made to the present invention within the scope of the claims. Embodiments resulting from appropriate combination of the technical means disclosed in the different embodiments are also included within the technical scope of the present invention. In addition, components with the same effect described in the above embodiments may be replaced with one another.

1-10. (canceled)

11: A user equipment (UE), comprising:
a processor; and
a memory in electronic communication with the processor, wherein instructions stored in the memory are executable to:
be configured with small data transmission (SDT);
be configured with configured grant resources for SDT transmission on an initial uplink bandwidth part (UL BWP);
in a case that the UE is in inactive state and a condition for SDT is fulfilled, transmit uplink data in the configured grant resources, the condition being that a timer related uplink alignment is running; and
monitor a physical downlink control channel (PDCCH) in a search space specific to SDT for receiving a response from network, wherein the search space is broadcasted in system information and wherein the response is a downlink assignment on the PDCCH scrambled by cell-radio network temporary identifier (C-RNTI).

12: A method performed by user equipment (UE), comprising:
being configured with small data transmission (SDT);
being configured with configured grant resources for SDT transmission on an initial uplink bandwidth part (UL BWP);
in a case that the UE is in inactive state and a condition for SDT is fulfilled, transmitting uplink data in the configured grant resources, the condition being that a timer related uplink alignment is running; and
monitoring a physical downlink control channel (PDCCH) in a search space specific to SDT for receiving a response from network, wherein the search space is broadcasted in system information and wherein the response is a downlink assignment on the PDCCH scrambled by cell-radio network temporary identifier (C-RNTI).
